(19) United States
(12) Patent Application Publication
(10) Pub. No.: US 2012/0140342 A1
(43) Pub. Date: Jun. 7, 2012

(54) Optical Lens Device

(75) Inventor: HSIANG-YU TSAI, Taipei City (TW)

(73) Assignee: ABILITY ENTERPRISE CO., LTD., TAIPEI (TW)

(21) Appl. No.: 13/093,675

(22) Filed: Apr. 25, 2011

(30) Foreign Application Priority Data
Dec. 6, 2010 (TW) 099142474

(51) Int. Cl. G02B 7/02

(52) U.S. Cl. 359/819

(57) ABSTRACT

An optical lens device is disclosed. The optical lens device includes an optical lens, a shading film, and a sensor. The shading film is disposed within the optical lens, and the shading film has an opening. The sensor is disposed at an imaging position. Wherein at least one light beam which enters the optical lens will access to the sensor, or will be blocked by the shading film.

### CROSS-REFERENCE TO RELATED APPLICATIONS

The entire contents of Taiwan Patent Application No. 099142474, filed on Dec. 6, 2010, from which this application claims priority, are incorporated herein by reference.

### BACKGROUND OF THE INVENTION

1. Field of the Invention

The present invention generally relates to an optical lens device, and more particularly to an optical lens device which is applied in a video capturing device.

2. Description of Related Art

Optical lens devices are widely applied in many kinds of the video capturing devices. The optical lens device usually includes an image sensor and an optical lens system which is composed of lenses. The captured object image passes through the designed optical path and is imaged on the image sensor. However, the environment light beam may also access to the image sensor through an unexpected path which is not the designed optical path. The light leakage issue occurs, and the image quality is affected by the environment light beam.

The conventional optical lens device usually has complex and sophisticated structure for avoiding the light leakage issue mentioned above. However, the complex and sophisticated structure usually has disadvantages. For example, the yield rate of the conventional optical lens device may be lower. The conventional optical lens device may be hard to assemble. And the conventional optical lens device may have higher cost.

For the reason that there are some disadvantages of the prior art mentioned above, there is a need to propose an optical lens device so as to meet consumer needs.

### SUMMARY OF THE INVENTION

Accordingly, the present invention has been made in order to meet such a need described above, and it is an object of the present invention to provide an optical lens device so as to meet consumer needs.

In order to achieve the above object, the present invention provides an optical lens device. The optical lens device includes an optical lens, a shading film, and a sensor. The shading film is disposed within the optical lens, and the shading film has an opening. The sensor is disposed at an imaging position. Wherein at least one light beam which enters the optical lens will access to the sensor directly, or will be blocked by the shading film.

By the optical lens device of the present invention, only the captured object image passes through the designed optical path and is imaged on the sensor. The additional environment light beam is blocked by the shading film, and the additional environment light beam will not access to the sensor. Thus, the light leakage issue is avoided.

### BRIEF DESCRIPTION OF THE DRAWINGS

FIG. 1 shows the sectional view of an optical lens device in accordance with an embodiment of the present invention;

FIG. 2 shows the operation of the optical lens device;

FIG. 3 shows the sectional view of an optical lens device in accordance with another embodiment of the present invention; and

FIG. 4 shows the sectional view of an optical lens device in accordance with another embodiment of the present invention.

### DETAILED DESCRIPTION OF THE INVENTION

The detailed description of the present invention will be discussed in the following embodiments, which are not intended to limit the scope of the present invention, and can be adapted for other applications. While drawings are illustrated in detail, it is appreciated that the quantity of the disclosed components may be greater or less than that disclosed, except where expressly restricting the amount of the components.

The present invention generally relates to an optical lens device which can avoid the light leakage issue. The optical lens device can be applied in the lens of digital cameras or the lens of video cameras.

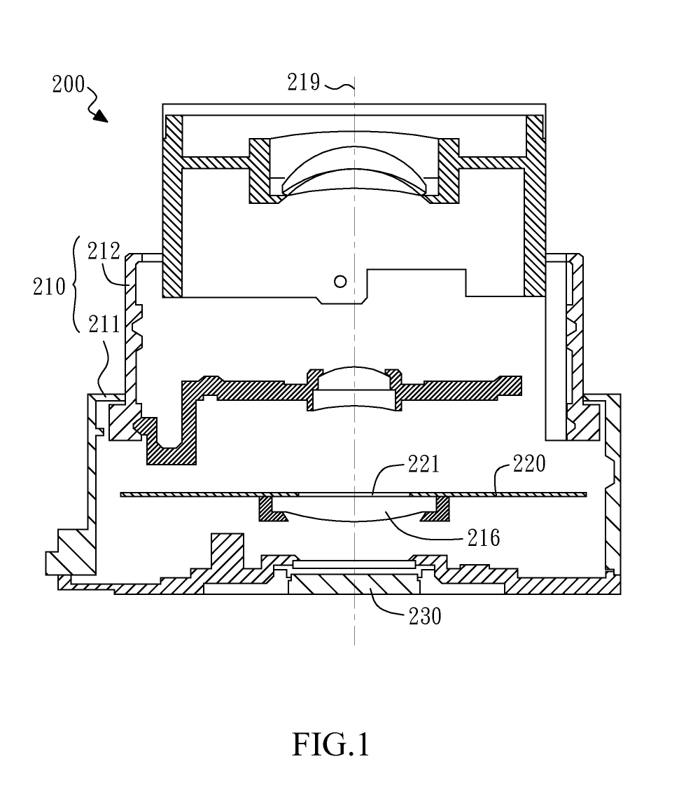

FIG. 1 shows the sectional view of an optical lens device 200 in accordance with an embodiment of the present invention. The optical lens device 200 includes an optical lens 210, a shading film 220, and a sensor 230. The optical lens 210 is used for focusing and imaging at least one light beam which enters the optical lens 210. The shading film 220 is disposed within the optical lens 210, and the shading film 220 has an opening 221. The sensor 230 is disposed at an imaging position for sensing the light beam imaged by the optical lens 210. Wherein the light beam enters the optical lens 210, the light beam which passes through the opening 221 will access to the sensor 230 directly. On the other hand, the light beam which does not pass through the opening 221 will access to the shading film 220 and be blocked or absorbed by the shading film 220. By using the shading film 220, the additional environment light beam can be filtered out. Thus, the light leakage issue which is caused by the additional environment light beam which accesses to the sensor 230 can be overcome.

Additionally, in this embodiment, the optical lens 210 includes an outer barrel 211 and an inner barrel 212. The inner barrel 212 is sleeved within the outer barrel 211, and the inner barrel 212 at least has a first lens 216. In practice, the shading film 220 is disposed to be vertical to an optical axis 219 of the optical lens 210, but is not limited to this. Specifically, the shading film 220 can be viewed as having a vertical projecting surface and a parallel projecting surface, wherein the vertical projecting surface is vertical to the optical axis 219 and the parallel projecting surface is parallel to the optical axis 219. Moreover, the diameter of the vertical projecting surface is between the diameter of the inner barrel 212 and the diameter of the outer barrel 211. Thus, the shading film 220 can block the light beam which passes through the clearance between the outer barrel 211 and the inner barrel 212.

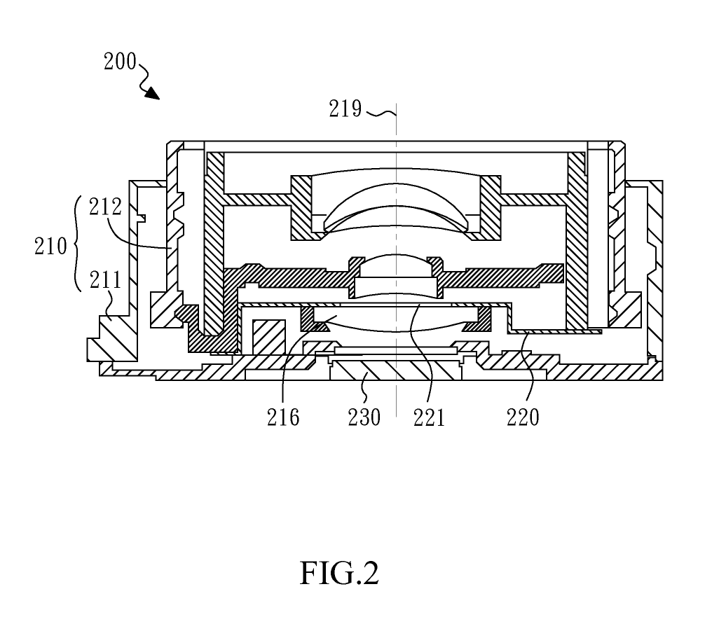

FIG. 2 shows the operation of the optical lens device 200. Please refer to FIG. 1. According to this embodiment, the shading film 220 is attached on the periphery of the first lens 216. If the first lens 216 is a focus lens, the shading film 220 moves as the first lens 216 during the focusing process. When the optical lens 210 is extended, the shading film 220 extends and blocks the light beam leaked. Furthermore, please refer to FIG. 2, when the optical lens 210 is enclosed, the shading film 220 can be deformed as the movement of the components of the optical lens 210. Finally, the shading film 220 can be enclosed within the gap of the components of the optical lens 210.

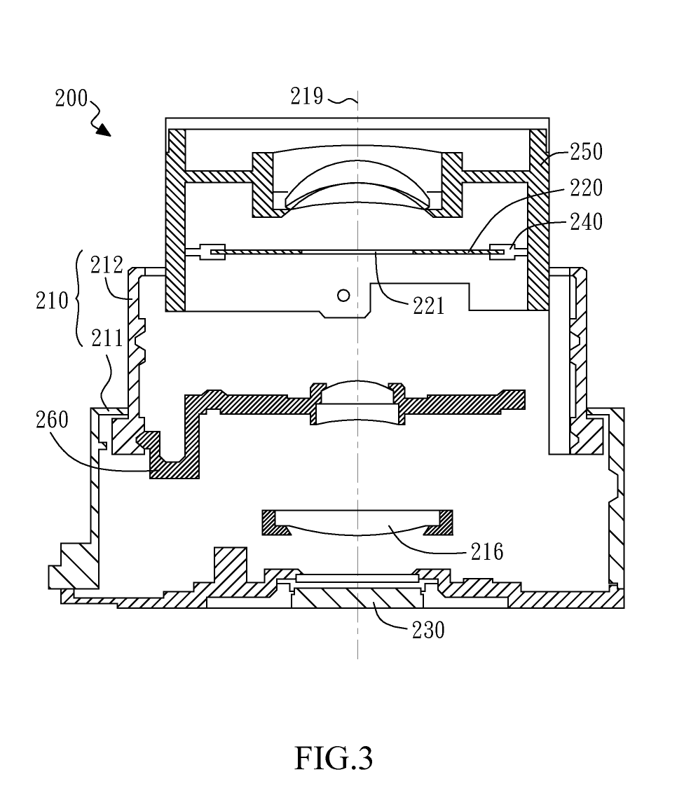

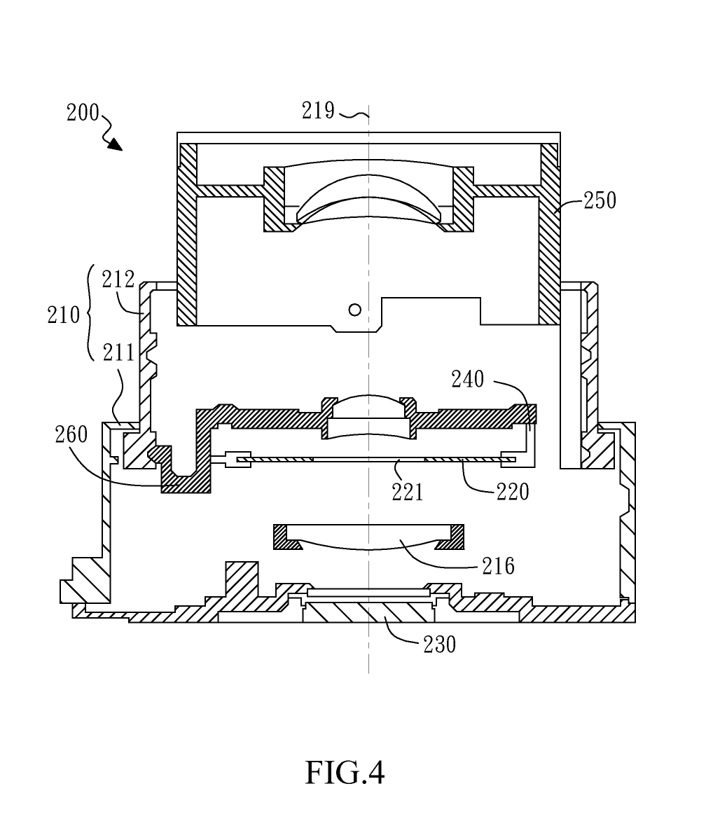

In this embodiment, the shading film 220 is attached on the first lens 216, but is not limited to this. Please refer to FIG. 3 and FIG. 4, the inner barrel 212 can include a frame 240 and at least one lens group, wherein at least one lens group includes at least one lens. The frame 240 is disposed between two lens groups or two lenses of the optical lens device 200. Specifically, in FIG. 3, the optical lens device 200 includes a first lens group 250 and a second lens group 260, wherein the frame 240 is disposed between the first lens group 250 and the second lens group 260. In FIG. 4, the frame 240 is disposed between the first lens 216 and the lens of the second lens group 260, wherein the lens is nearest to the object side. The shading film 220 is disposed on the frame 240. Whereby, the shading film 220 can also block the leaked light beam.

According to this embodiment, the shading film 220 can be made of a flexible material and be a flexible shading film. Specifically, the shading film 220 can be made of resin materials, rubber materials, synthetic materials, plastics, or a combination of these three materials. On the other hand, the shading film 220 can be made of a material having flexibility and visible light absorbing properties, but is not limited to this. In this embodiment, the shading film 220 is preferably made of Polyurethane (PU), and the thickness of the shading film 220 is preferably 0.03 mm. The shading film 220 has proper flexibility; the shading film 220 can be deformed as the movement of the components of the optical lens 210. When the optical lens 210 is enclosed, the shading film 220 can be enclosed within the gap of the components of the optical lens 210. When the optical lens 210 is extended, the shading film 220 extends and blocks the light beam leaked.

For preventing the light beam blocked by the shading film 220 from reflecting in other directions, an object side of the shading film 220 can be a matt surface, or a rough surface made by a sandblast process so as to reduce light beam reflection. Furthermore, the shading film 220 can be a black film, or the shading film 220 can be made of an optical absorbing material. The light beam, which accesses to the shading film 220, can be absorbed by the shading film 220 directly. Thus, the light beam will not be reflected by the shading film 220 again.

By the design mentioned above, the environment light beam, which enters the optical lens device 200 through the unexpected path except the designed optical path, will be blocked or absorbed by the shading film. Thus, the environment light beam will not access to the image sensor 230. And the light leakage issue is avoided. The picture capturing device having the optical lens device 200 can meet consumer needs for the picture capturing device.

Although specific embodiments have been illustrated and described, it will be appreciated by those skilled in the art that various modifications may be made without departing from the scope of the present invention, which is intended to be limited solely by the appended claims.

What is claimed is:

1. An optical lens device, comprising:
an optical lens;
a shading film, said shading film disposed within said optical lens, said shading film having an opening; and
a sensor, said sensor disposed at an imaging position;
wherein at least one light beam which enters said optical lens accesses to said sensor or is blocked by said shading film.

2. The optical lens device according to claim 1, wherein said at least one light beam which passes through said opening will access to said sensor, or said light beam which does not pass through said opening will be blocked by said shading film.

3. The optical lens device according to claim 1, wherein said optical lens comprises a frame, and said shading film is disposed on said frame.

4. The optical lens device according to claim 3, wherein said optical lens comprises a plurality of lenses, and said frame is disposed between two of said lenses.

5. The optical lens device according to claim 1, wherein said optical lens comprises a first lens, and said shading film is attached on said first lens.

6. The optical lens device according to claim 1, wherein said shading film has a projecting surface which is vertical to an optical axis of said optical lens.

7. The optical lens device according to claim 1, wherein said shading film is a flexible shading film or a black film.

8. The optical lens device according to claim 1, wherein an object side of said shading film is a matt surface.

9. The optical lens device according to claim 1, wherein said shading film is made of an optical absorbing material.

10. The optical lens device according to claim 1, wherein said shading film is made of Polyurethane, and a thickness of said shading film is 0.03 mm.

11. An optical lens device, comprising:
an optical lens, comprising:
an outer barrel;
an inner barrel, said inner barrel sleeved within said outer barrel, and said inner barrel having a first lens; and
a shading film, said shading film disposed within said optical lens, and said shading film having an opening; and
a sensor, said sensor disposed at an imaging position;
wherein at least one light beam which enters said optical lens accesses to said sensor, or is blocked by said shading film.

12. The optical lens device according to claim 11, wherein said at least one light beam enters said optical lens, said at least one light beam which passes through said opening will access to said sensor, or said at least one light beam which does not pass through said opening will be blocked by said shading film.

13. The optical lens device according to claim 11, wherein said shading film has a projecting surface which is vertical to an optical axis of said optical lens, and a diameter of said projecting surface is between the diameter of said inner barrel and the diameter of said outer barrel.

14. The optical lens device according to claim 11, wherein said shading film is attached on said first lens.

15. The optical lens device according to claim 11, wherein said optical lens comprises a frame, and said shading film is disposed on said frame.

16. The optical lens device according to claim 15, wherein said optical lens comprises a plurality of lenses, and said frame is disposed between two of said lenses.

17. The optical lens device according to claim 11, wherein said shading film is made of a flexible material or an optical absorbing material.

18. The optical lens device according to claim 11, wherein an object side of said shading film is a matt surface.

19. The optical lens device according to claim 11, wherein a color of said shading film is black.

20. The optical lens device according to claim 11, wherein said shading film is made of Polyurethane, and a thickness of said shading film is 0.03 mm.
